(19) United States
(12) Patent Application Publication
(10) Pub. No.: US 2015/0058021 A1
(43) Pub. Date: Feb. 26, 2015

(54) Miniature, Wearable, Kitchen Ordering Apparatus

(71) Applicant: Jijesoft Co., Ltd., Suzhou (CN)

(72) Inventors: Zuojun Min, Suzhou Jiangsu (CN); Li Xinrui, Suzhou Jiangsu (CN)

(21) Appl. No.: 14/467,288

(22) Filed: Aug. 25, 2014

(30) Foreign Application Priority Data
Aug. 23, 2013 (CN) 201310372644.9

(51) Int. Cl. G06Q 50/12; H04R 1/02; G06F 1/16; G10L 15/22; G06F 3/16

(52) U.S. Cl. CPC G06Q 50/12; G10L 15/22; G06F 3/167; G06F 1/163; G06F 1/1652; H04R 1/028
USPC 704/275

(57) ABSTRACT

A miniature, wearable, kitchen ordering apparatus having a wearable bracket, a control box coupled to the bracket, a circuit board in the control box, a display output port, wireless communications unit, data processing unit, voice analyzer unit, and an audio pickup module, all operably connected to the circuit board. The output terminal of the audio pickup module is operably connected to the voice analyzer unit input terminal, the output terminal from the voice analyzer unit connects to the data processing unit input terminal, the digital communications port on the data processing unit connects to the wireless communications unit, and the data processing unit display interface connects to the display output port, which in turn connects to a flexible display panel installed on the wearable bracket. There is a battery connected to the data processing unit.

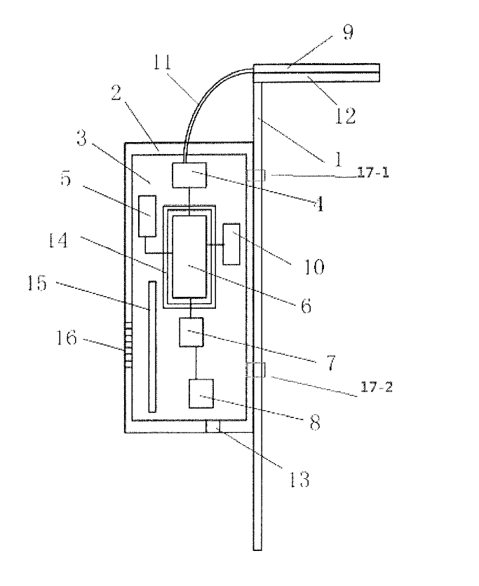

### CROSS-REFERENCE TO RELATED APPLICATION

This application claims priority of Chinese Patent Application Number 201310372644.9, entitled “A Miniature, Wearable, Kitchen Ordering Apparatus” filed on 23 Aug. 2013, the entire disclosure of which is incorporated herein by reference.

### FIELD

This disclosure involves a food ordering apparatus, specifically a miniature, wearable, kitchen ordering apparatus.

### BACKGROUND

The overall workflow for current common kitchen ordering systems is that food orders are first entered using forms that are part of the ordering software; a controller then passes the forms to a display in the kitchen, and the kitchen prepares the food when it sees the orders. After food is sent out, the orderer changes the form state to show that the food has been served, and the kitchen can use a keyboard to enter the form's serial number and delete the form.

There are several problems with this arrangement. Commercial kitchens have extremely stringent health requirements, and this sort of touch input apparatus could pose a threat to health. Also, this process is time consuming. Further, the costs of manufacturing such an apparatus are currently far higher than for ordinary keyboards, because of the requirement for high durability in the face of extremely frequent use.

### SUMMARY

A purpose of the miniature, wearable, kitchen-ordering apparatus is to resolve the above issues that exist with current technologies, by providing a miniature, wearable, kitchen ordering apparatus. This purpose is achieved by means of the following technical solutions.

Featured herein is a miniature, wearable, kitchen ordering apparatus that includes a wearable bracket. The apparatus features a control box mounted on the wearable bracket, a plug-in control circuit board installed in the control box, and an audio pickup module connected to the circuit board. The audio pickup module output terminal connects to a voice analyzer unit input terminal, and the voice analyzer unit output terminal connects to a data processing unit input terminal. This data processing unit has a digital communications port that connects to a wireless communications unit, and a display interface that connects to a display output port. A flexible display panel is installed on the wearable bracket, and connects to the display output port. There is a battery connected to the data processing unit.

The apparatus is able to accept voice commands because of the above features, and thus hands-free input of control commands can be accomplished, as can tasks related to ordering from a menu. The construction of the apparatus is streamlined, it is relatively sturdy and dissipates heat relatively well, and it is easy to wear.

A miniature, wearable, kitchen ordering apparatus includes a wearable bracket (e.g., an eyeglass frame) with a small, unobtrusive control box installed on it. There is a plug-in control circuit board installed in this control box. A display output port, wireless communications unit, data processing unit, voice analyzer unit, and audio pickup module connect to this board. The output terminal of the audio pickup module connects to the voice analyzer unit input terminal, and the voice analyzer unit output terminal connects to the data processing unit input terminal. The digital communications port on the data processing unit connects to the wireless communications unit, and the data processing unit display interface connects to the display output port. There is a flexible display panel that connects to the display output port and is installed on the wearable bracket. The display may be mounted such that it is held proximate a portion of a lens of the eyeglasses. There is a battery connected to the data processing unit.

The aforementioned ordering apparatus may also include:
a flexible cable installed between the display output port and the flexible display panel;
a lens installed on the wearable bracket, with the flexible display panel integrated closely in front of or behind it;
a lens frame installed on the wearable bracket, with the flexible display panel integrated closely in front of or behind it;
a hole in the control box to allow the user's voice commands to enter the control box and be picked up by the microphone.
adjustable loops (e.g., eyeglass earpieces) to hold the wearable bracket on the ears, or against the head near the ears;
screw holes in the control box and positioning holes on the circuit board, with the two items connected by screws;
accommodation grooves in the control box that seat the circuit board;
one or more reinforcing ribs in the control box, to strengthen the box as needed;
an optional heat sink in the control box; and
holes in the control box to dissipate heat.

The merits of these technical solutions are mainly embodied in the capability to accept voice commands and accomplish hands-free input of control commands. Furthermore, with the support of wireless communications devices, the subject apparatus can effectively exchange data with current kitchen ordering systems and accomplish tasks related to ordering from a menu. For example, kitchen staff wearing the apparatus can read the screen on the apparatus without having to look up at a separate monitor, and can input to the system with their voice, thus avoiding the need to move their hands from the current task, and avoiding the need for a keyboard or other input device that must be touched. The apparatus has streamlined construction, is relatively sturdy and dissipates heat relatively well, and is easy to wear.

Further purposes, merits, and characteristics of this invention will be illustrated and explained below through a non-restrictive description of a preferred implementation. This implementation refers to the attached diagram only as an example.

### DESCRIPTION OF FIGURE

The FIGURE is a schematic structural diagram of a non-limiting example of a miniature, wearable, kitchen ordering apparatus.

The following table maps the indicated numbers to locations on the FIGURE.

1 Wearable Bracket

2 Control Box

3 Plug-in Control Circuit Board

4 Display Output Port

5 Wireless Communications Unit

6 Data Processing Unit

7 Voice Analyzer Unit

8 Audio Pickup Module

9 Flexible Display Panel

10 Battery

11 Flexible PCB Cable

12 Lens Frame

13 Hole for Voice Communication

14 Accommodation Groove

15 Reinforcing Rib

16 Heat Dissipation Holes

17-1 and 17-2 Rubber rings that hold the control box on the frame and allow its position to be adjusted along the length of the frame

### PREFERRED IMPLEMENTATION

The miniature, wearable, kitchen ordering apparatus depicted in the drawing includes a wearable bracket (“1”), a unique aspect of which is that, in order to achieve integrated construction, it has a control box (“2”) installed on the bracket (“1”); there is a plug-in control circuit board (“3”) in the control box (“2”). Meanwhile, the circuit board (“3”) has slots, and a display output port (“4”), wireless communications unit (“5”), data processing unit (“6”), voice analyzer unit (“7”), and audio pickup module (“8”) connect to these slots. The output terminal of the audio pickup module (“8”) connects to the voice analyzer unit (“7”) input terminal, and the voice analyzer unit (“7”) output terminal connects to the input terminal on the data processing unit (“6”). In addition, the digital communications port on the data processing unit (“6”) connects to the wireless communications unit (“5”), the data processing unit (“6”) display interface connects to the display output port (“4”), and a flexible display panel (“9”) connects to the display output port. The display panel (“9”) is installed on the wearable bracket (“1”), and a battery (“10”) connects to the data processing unit (“6”).

In specific terms, the audio pickup module (“8”) is used to physically receive the voice commands given by the wearer. There are optional design goals for this module. First, the orientation of the audio pickup can be made adjustable to accommodate the installed position of the apparatus and the wearer's posture, such that the pickup is oriented properly to the position of the wearer's mouth. Second, the audio pickup sensitivity can be made adjustable, through parameters like gain, to properly match the sound level that may be picked up within the range of voice commands commonly used by the wearer; this audio sensitivity will ultimately be determined by testing for limits and general effectiveness. This can be accomplished by allowing the longitudinal and/or rotational position of the control box on the wearable bracket to be adjusted.

These two goals are intended to provide for physical design measures that increase resistance to interference. This is because kitchens are very high-noise environments. A manner in which these two goals can be accomplished is to include rubber rings 17-1 and 17-2 that tightly hold control box 2 on wearable bracket 1. The position of the rings can be changed relative to the bracket (e.g., along the length of the eyeglass earpieces), and the rotational position of the control box on the bracket can be changed and then the box can be held in this desirable longitudinal and rotational position by the multiple rubber rings. Other mechanical devices (such as clips or a detent arrangement) could be used to hold the control box to the frame, or the control box could potentially be fixed to the frame, or a part of the frame itself could be enlarged and act as the control box. The control box is preferably but not necessarily adjustable relative to the bracket.

The voice analyzer unit (“7”) responds to voice signals received along the physical pathway and puts them through the system's noise-canceling and amplification processing, comparing the output with a stored lexicon of corresponding commands, transforming them into logical commands and transmitting them to the main data processing module. Upon receiving these logical commands, the data processing unit (“6”) executes the corresponding processes in sequence and passes the results to the display output interface (“4”), modifying the content shown by the flexible display panel (“9”). Meanwhile, the content on the display panel (“9”) will generally be divided into a certain number of small windows that show various menu contents and processing states.

Non limiting examples follow. For example, if a cook wears this apparatus, when he sees a new menu item displayed on the screen with the status New and tendered' from the point-of-sale device, he may start to prepare this food item. After he finishes the preparation of the food item, he sends a voice command to tell the apparatus the food is prepared. Then this menu item will have the status ‘Ready to serve’ on all screens. Meanwhile the waiter (who could also wear an apparatus) sees this status change, he would get this food to the table. He could send a voice command to tell the apparatus that the food is “Served”. If the software verifies this menu item's status as ‘Served’, it would automatically bump this served menu item from the screen.

In a preferred implementation of this disclosure, a flexible cable connects the display output port (“4”) with the flexible display panel (“9”), in order to increase service life and satisfy the need for relatively flexible image data transmission. There is also a lens on the wearable bracket (“1”), with the flexible display panel (“9”) bonded to (or mounted against or close to) its outside, given that this may facilitate user viewing and display relatively good image output; of course, the display panel could be bonded to or held against or near the inside of the lens instead. In addition, a simplified design could be adopted to reduce weight, wherein a lens frame (“12”) (e.g., without a lens in it) is on the wearable bracket (“1”), with the display panel (“9”) inside or outside the frame (“12”).

There is also a hole (“13”) in the control box for voice communication (“2”), to facilitate smooth speech recognition; there is an anti-noise plug in the hole (“13”), to guard against possible noise interference and improve recognition. There can also be adjustable ear loops to adapt to wearing on different faces.

At the same time, to provide for the plug-in control circuit board (“3”) to have a solid mounting position and not move around, there are screw holes in the control box (“2”) and positioning holes on the board (“3”). Screws connect the circuit board to the control box.

Further, in order to prevent unnecessary displacement of the installed unit that would adversely affect use, there are accommodation grooves (“14”) in the control box (“2”) for all components (e.g., for the circuit board). There is also a reinforcing rib (“15”) inside the control box (“2”) to enhance its overall sturdiness.

In addition, given that various components are likely to generate heat during processing, and to increase service life and dissipate heat effectively, there are heat dissipation holes (“16”) in the control box (“2”).

In terms of integrating the apparatus into actual use, the control box (“2”) is constructed as a thin (6 centimeter×3 centimeter×2 centimeter) cuboid shape, not to exceed 100 grams in weight, which can be attached to a wearable bracket (“1”) similar to spectacles. This form factor does not create noticeable weight pressure for the wearer, and it conforms to health requirements for human body mechanics. The standard for flexible display panels is 25 millimeters×25 millimeters, and the panels are transparent when not displaying content, thus preserving the wearer's field of vision to the extent possible.

When used in lieu of a traditional wired network, given reliable wireless transmission technology the apparatus interacts with front-of-house kitchen equipment (to receive menus and return processing output, for example), and with data transmission by back-of-house data servers (to carry out data management and record processing, for example).

In terms of practical application, in order to make voice input more resistant to interference in the sense of command logic, the command lexicon can be a collection that is limited in number and simple in design. For example, the schema for all commands can be summarized as <menu screen |1, 2, . . . n|action> (because the display panel is normally divided into 8 or 10 windows to show different menus and processing states), or as <menu screen 1 complete>, <menu screen 2 cancel>, <menu screen 3 account settled>. This approach to command design can greatly reduce the computing capacity needed for voice recognition and analysis functions, as well as the space needed to store a speech library. Some supervisory commands can also be added based on application status, such as <system restart>, <system shutdown>, and <system start>.

It can be seen from the foregoing that, after this apparatus is adopted, voice commands can be accepted and hands-free input of control commands can be accomplished. Furthermore, with the support of wireless communications devices, the apparatus can effectively exchange data with current kitchen ordering systems in order to accomplish tasks related to ordering from a menu. Also, the apparatus has streamlined construction, is relatively sturdy and dissipates heat relatively well, and is easy to wear.

Of course, the above is only an example of a specific application for this invention, and it does not constitute any limit on the scope of protection for the invention; there could be other implementations besides the one depicted above. Any equivalent or substitute technical solutions that are used to embody a miniature, wearable, kitchen ordering apparatus fall within the scope of what requires protection pertaining to this invention.

1. A miniature, wearable, kitchen ordering apparatus, comprising:
a wearable bracket;
a control box coupled to the bracket;
a circuit board in the control box;
a display output port, wireless communications unit, data processing unit, voice analyzer unit, and an audio pickup module, all operably connected to the circuit board;
wherein the output terminal of the audio pickup module is operably connected to the voice analyzer unit input terminal, the output terminal from the voice analyzer unit connects to the data processing unit input terminal, the digital communications port on the data processing unit connects to the wireless communications unit, and the data processing unit display interface connects to the display output port, which in turn connects to a flexible display panel installed on the wearable bracket; and
a battery connected to the data processing unit.

2. The apparatus of claim 1, further comprising a flexible cable interconnecting the display output port and the flexible display panel.

3. The apparatus of claim 1, further comprising a lens coupled to the wearable bracket, wherein a flexible display panel is located closely in front of or behind the lens.

4. The apparatus of claim 1, further comprising a lens frame coupled to the wearable bracket, wherein a flexible display panel is located closely in front of or behind the lens frame.

5. The apparatus of claim 1, further comprising a hole in the control box located such that voice communication from the wearer can reach the audio pickup.

6. The apparatus of claim 1, further comprising one or more adjustable loops that are used to hold the wearable bracket on the ears or against the head of the user.

7. The apparatus of claim 1, further comprising screw holes in the control box and positioning holes on the circuit board, where the two are interconnected with screws passing through or into the holes.

8. The apparatus of claim 1, further comprising one or more grooves in the control box into which the circuit board is seated.

9. The apparatus of claim 1, further comprising one or more reinforcing ribs in the control box.

10. The apparatus of claim 1, further comprising holes in the control box to dissipate heat.

11. The apparatus of claim 1 wherein the wearable bracket comprises an eyeglass frame with earpieces, and the control box is coupled to an earpiece.

12. The apparatus of claim 11 wherein the control box is movably coupled to an earpiece, to allow the control box to be moved along the length of the earpiece and rotationally relative to the earpiece.

13. The apparatus of claim 12 wherein the movable coupling is accomplished with a plurality of elastic rings.

14. A miniature, wearable, kitchen ordering apparatus, comprising:
an eyeglass frame with an earpiece;
a control box coupled to the earpiece;
a circuit board in the control box;
a display output port, wireless communications unit, data processing unit, voice analyzer unit, and an audio pickup module, all operably connected to the circuit board;
wherein the output terminal of the audio pickup module is operably connected to the voice analyzer unit input terminal, the output terminal from the voice analyzer unit connects to the data processing unit input terminal, the digital communications port on the data processing unit connects to the wireless communications unit, and the data processing unit display interface connects to the display output port, which in turn connects to a flexible display panel installed on the wearable bracket;
a battery connected to the data processing unit;
a flexible cable interconnecting the display output port and the flexible display panel;
one or both of a lens frame and a lens coupled to the eyeglass frame, wherein a flexible display panel is located closely in front of or behind the lens frame or the lens.

15. The apparatus of claim 14 wherein the control box is movably coupled to an earpiece, to allow the control box to be moved along the length of the earpiece and rotationally relative to the earpiece.

16. The apparatus of claim 15 wherein the movable coupling is accomplished with a plurality of elastic rings.
